(19) United States
(12) Patent Application Publication
(10) Pub. No.: US 2023/0148819 A1
(43) Pub. Date: May 18, 2023

(54) FILTER UNIT FOR THE INTAKE CONNECTOR IN THE DIRTY-WATER TANK OF A FLOOR-CLEANING MACHINE

(71) Applicant: Hako GmbH, Bad Oldesloe (DE)

(72) Inventors: Jens THIELE-FIESINGER, Bad Segeberg (DE); Christian TABELING, Stockelsdorf (DE)

(21) Appl. No.: 17/987,170

(22) Filed: Nov. 15, 2022

(30) Foreign Application Priority Data
Nov. 16, 2021 (WO) 21208487.5

(51) Int. Cl. A47L 11/40; A47L 11/20; B01D 46/00; A47L 11/30

(52) U.S. Cl. CPC A47L 11/4027; A47L 11/20; B01D 46/0005; B01D 46/0015; A47L 11/30

(57) ABSTRACT

A floor cleaning machine with a filter unit for a suction connector in a dirty-water tank. The filter unit has a substantially sleeve-shaped main body, which has an inlet opening at a face end, a substantially annular float body, which is arranged around and is displaceable along the main body between a closed position and an open position, a cover, which is arranged on the face end and has an entry opening that is configured to be selectively closed off by the float body. A fluid channel is provided in the cover and is configured to allow a fluid to flow from the entry opening into the inlet opening, and a sleeve-shaped filter element. The float body is arranged around the main body in an annular space between the main body and the filter element.

### CROSS-REFERENCE TO RELATED APPLICATIONS

This application claims the benefit of European Patent Application No. 21208487.5 filed Nov. 16, 2021, the disclosure of which is incorporated by reference as if fully set forth in detail herein.

### FIELD

The present disclosure relates to a filter unit for the intake connector or suction connector in the dirty-water tank of a floor-cleaning machine, and to a floor-cleaning machine, in particular a scrubber dryer, having such a filter unit.

### BACKGROUND

Floor-cleaning machines, or scrubber dryers, known from the prior art that can be moved by means of a chassis over a floor surface to be cleaned have a brush head which is provided with driven brushes which can engage with the floor surface to be cleaned, wherein, in the region of the brush head, cleaning liquid is applied to the floor surface to be cleaned in order for dirt adhering thereto to be detached. Behind the brush head as seen in the direction of travel of the scrubber dryer, there is then normally arranged a so-called suction foot, with the aid of which cleaning liquid applied beforehand to the floor surface to be cleaned can be extracted by suction again into a dirty-water tank of the machine. For this purpose, provision is made of a suction turbine which is connected via an intake connector to the interior of the dirty-water tank in order to generate negative pressure therein, wherein further a suction line leads from the interior of the dirty-water tank to the suction foot, so that, by way of the suction turbine, a suction region of the suction foot is subjected to negative pressure. This in turn leads to it being possible for a suction-air stream from the suction foot into the dirty-water tank to be generated, by way of which cleaning liquid situated on the floor surface to be cleaned is entrained into the dirty-water tank.

Here it is disadvantageous if foam, dirty water itself and dirt particles contained in the dirty water or in the suction-air stream pass into the suction turbine, since both can lead to damage to the suction turbine or to an electric motor driving said suction turbine. It is therefore also known from the prior art for provision to be made on the intake connector of a filter unit which prevents at least dirt particles from passing into the intake connector and thus the suction turbine. Furthermore, it is also known for provision to be made at the intake connector of a float valve which closes off the intake connector if the liquid level in the dirty-water tank has reached a predefined maximum level.

However, such filter units and float valves known from the prior art have proven to be disadvantageous because it is often not ensured that the filter unit is also re-fitted in the correct manner by a user, so that, after a cleaning process, the filter unit is correctly positioned with the float valve and prevents the passage of dirt or cleaning liquid toward the suction turbine. Moreover, the filter units and float valves known from the prior art do not reliably prevent entry of foam into the suction turbine.

It is therefore one object of the present disclosure to provide a filter unit with valve for the intake connector in the dirty-water tank of a floor-cleaning machine that is reliable and easy to fit. Furthermore, it is desirable that it also reliably prevents entry of foam into the suction turbine.

### SUMMARY

This section provides a general summary of the disclosure, and is not a comprehensive disclosure of its full scope or all of its features.

In one form, the disclosure provides a filter unit with valve for the intake connector in the dirty-water tank of a floor-cleaning machine that is reliable and easy to fit. Furthermore, it is desirable that it also reliably reduce or eliminate entry of foam into the suction turbine.

In some examples, a filter unit for a suction connector of a floor-cleaning machine is provided in having a suction connector in the dirty-water tank of the floor-cleaning machine. The filter unit has a substantially sleeve-shaped main body, which extends between a first face end and a second face end and has an inlet opening at the first face end. The filter unit furthermore has a substantially annular float body, which is arranged around the main body and is displaceable along the main body between a closed position and an open position. The filter unit furthermore has a cover, which is arranged on the first face end of the main body, wherein the cover has at least one entry opening which is configured to be closed off by the float body when the latter is in the closed position and which is open when the float body is at a distance from the closed position. Provision is made in the cover of a fluid channel, which is configured to allow a fluid to flow from the entry opening into the inlet opening. The filter unit furthermore has a sleeve-shaped filter element, which is arranged around the main body in such a way that, between the main body and the filter element, there is formed an annular space in which the float body is arranged so as to be displaceable between the closed position and the open position. The filter element is formed at least partially from a filter material such that a fluid can pass through the filter material, while particles contained in the fluid are separated out at the filter material. The filter material may be arranged on a circumferential surface of the filter element.

In some forms, a float valve can be easily mounted onto the intake connector in the dirty-water tank of a scrubber dryer in that the sleeve-shaped main body is pushed over the intake connector.

Optionally, the main body can be part of the intake connector and possibly even formed in one piece therewith.

When the level in the dirty-water tank increases during and as a consequence of the operation of the floor-cleaning machine and, in the process, increasingly raises the float body in the annular space, the float body can close off the entry opening (closed position). Closure of the entry opening then prevents dirty water from passing from the dirty-water tank into the suction turbine situated downstream and damaging the latter. When the entry opening has been closed off by the float body, this can be indicated to the user of the scrubber dryer, wherein firstly it is possible that the motor current of the suction turbine, which drops as a result of the closure, leads to a corresponding signal for the user being produced. Secondly, it is also conceivable for a switch or a contactless sensor to be actuated by the float valve and, in this way, for a corresponding signal for the user to be generated.

A similar effect is also achieved if, during the travel of the scrubber dryer, the level in the dirty-water tank varies greatly, and the float body is raised to a great extent only for a short time. Then, likewise, the entry opening is closed off, and this can be indicated to the user. In such a case, too, it is ensured that no dirty water passes to the suction turbine.

Additionally, the filter element, which surrounds the annular space and the main body, prevents dirt particles contained in the suction-air stream from being able to pass through the entry opening and an opening to the suction turbine. When the filter element or the filter material provided thereon is so dirty that only a small air stream passes through, this can also lead to the float body being drawn against the entry opening and closing off the latter. This can then be indicated to the user by means of the possibilities already described.

Since the float body is arranged in the annular space and is guided by the main body, a compact construction is the result overall, and the float body is held captively on the main body such that, if the filter element is dismounted for cleaning purposes, said float body cannot be lost, which would have the consequence that, after a recommencement of operation after the cleaning of the filter element, the closing action, with too high a level in the dirty-water tank, would no longer be provided and dirty water could enter the suction turbine without hindrance.

In some forms, the filter element can be held in a detachable manner on the cover. The filter element can be pulled off from the cover, cleaned and remounted. The filter element may in this case furthermore preferably have a grip, wherein detachment from the cover can be simplified. A dimension or inner diameter of the filter element can be matched to the cover in such a way that the filter element is held on the cover by way of a transition fit, or slight press fit, in order to prevent loss for example during tilting of the dirty-water tank for servicing purposes. This embodiment is particular easy to fit and/or to service.

In some forms, the main body can have an encircling flange which extends away in an outward direction and against which the float body bears when the float body is in the open position, and the filter element extends as far as the flange. The flange may serve as a stop during the mechanical connection of the filter element, in particular after a cleaning process. Moreover, the flange can prevent a partial stream of the suction-air stream from entering the annular space while bypassing the filter element.

In some forms, the flange may have at least one opening or flange opening which is closed off by the float body when the float body is in the open position and which is opened up when the float body has been displaced from the open position toward the closed position. This flange opening can offer a further flow channel into the annular space, and a flow through this flange opening can facilitate a transfer of the float body into the closed position. In particular if the filter element has become increasingly dirty, or if foam forms in the dirty-water tank, then the flange opening can increase the protective action by the filter unit. This embodiment can make it possible that, in the case of a clogged filter element, air can flow through the flange opening and said air can displace the float body into its closed position. Finally, the flange opening additionally makes it possible that foam possibly situated in the dirty-water tank moves the float body also in the direction of the closed position. In this way, it is thus achieved that foam, which forms above the dirty-water level and would present a risk to the suction turbine, also leads to closure of the entry opening by way of the float body, which protects the suction turbine and is in turn indicated to a user.

In the region of the inlet opening, the main body can have at least one latching element, preferably at least one latching hook. The at least one latching element is configured to engage with at least one engagement element at the suction connector. The main body and the cover are configured in such a way that, when the at least one latching element is in engagement with the engagement element, a fluid connection between the entry opening and the suction connector is provided. The main body and the cover may be configured in such a way that, when the at least one latching element is in engagement with the engagement element of the suction connector, a fluid can flow into the suction connector through the entry opening of the cover and through the inlet opening of the main body. In this embodiment, the filter element can be simply attached to a suction connector.

In some forms, a locking body may be provided, wherein the locking body has a cylindrical portion, and wherein the cylindrical portion is inserted into the inlet opening and is configured to counteract action of bringing the latching element out of engagement with respect to the suction connector. In this embodiment, after the insertion of the locking body, the main body is in a state fixedly connected to the suction connector. Moreover, the locking body can counteract leaks between main body and intake connector.

In some forms, the locking body may have an encircling collar which extends beyond the main body into the annular space. The float body may bear against the collar in the closed position. The collar may contribute to the definition of the closing position. The cover may be mechanically connected to the first face end of the main body, and clamp the collar of the locking body in the process.

In some forms, the cover and the main body may be components which are separate from one another, wherein the locking body, in particular the collar thereof, is arranged between the cover and the main body. In this embodiment, the filter unit may be fitted in such a way that, firstly, the main body is mounted onto the intake connector, wherein the latching elements engage with the intake connector. Then, the locking body is inserted into the inlet opening of the main body such that detachment of the latching elements from the intake connector is prevented and the main body is thus locked to the intake connector. Subsequently, the cover is fastened to the main body such that the locking body can then no longer be detached from the main body. The main body can then be detached from the intake connector only if, beforehand, the cover is removed and then the locking body is removed from the inlet opening. This construction thus makes it possible in a simple manner for the main body to be securely fastened to the intake connector. Furthermore, the collar of the locking body secures the float body against separation from the main body and loss if the filter element, for example for the purpose of cleaning the cover and the main body, is pulled off.

In some forms, an elastic ring element is provided which bears against a surface of the main body facing away from the cover, wherein the ring body is provided to bear against the suction connector. This embodiment is more resistant to vibrations during the operation of the floor-cleaning machine. The elastic ring element may moreover serve to compensate for manufacturing tolerances, in particular of the main body and the suction connector. Furthermore, the elastic ring element prevents leaks, in particular between the suction connector and the main body.

Optionally, the filter element has a sieve-like circumferential surface. This allows the cleaning of the filter element to be simplified.

In some forms, the main body has a tubular portion around which the float body can be arranged, wherein the tubular portion can be fitted over a suction connector of a floor-cleaning machine. Said main body can be arranged and centered relative to the suction connector in a simple manner.

In some forms, the filter unit is incorporated into a scrubber-dryer having a dirty-water tank, a suction connector, which extends into the dirty-water tank, a suction turbine, which is fluidically connected to an end of the suction connector that is remote from the dirty-water tank and which serves for generating negative pressure in the dirty-water tank, a suction line, which ends in the dirty-water tank and which is connected to a device for receiving liquid, by way of negative pressure, from a floor surface to be cleaned. In the case of said floor-cleaning machine, provision is made of one of the above-described filter units, which is mechanically connected to that end of the suction connector which is arranged in the dirty-water tank.

In some forms, the floor cleaning machine has a chassis by way of which it can be moved over a floor surface to be cleaned, wherein furthermore preferably provision is made at the machine of a cleaning device which can come into engagement with the floor surface to be cleaned and by way of which cleaning liquid can be applied to the floor surface.

In this context, it should be pointed out that the present invention may be used both for self-driving floor-cleaning machines or scrubber dryers, in the case of which a user rides on the machine, and for machines in the case of which a user walks in front of the machine or behind the machine.

The floor-cleaning machine may have a current sensor which can detect the current intensity of the electric current consumed by the suction turbine.

During the operation of said floor-cleaning machine, the fill level in the dirty-water tank can exceed a maximum value, an undesired volume of foam can form in the dirty-water tank, and/or the filter element of the filter unit can become increasingly clogged. In these cases, the float body, in particular because of the opening in the flange of the main body, can assume the closed position and prevent undesired ingress of liquid into the suction turbine. In the case of the closed position being assumed, the current consumption of the suction turbine is changed and, in particular, it is possible to recognize the change in current in a current-time curve as a kink or as a discontinuity. Owing to this change in current, a signal may be indicated to a user, and, in response to this signal, a user should service the floor-cleaning machine, that is to say clean the filter and/or empty the dirty-water tank. However, it is also conceivable for a switch or a contactless sensor to detect whether the float body is in the closed position. Here, too, a corresponding signal indicating the closure to the user can then be generated.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a view of a scrubber dryer with an exemplary embodiment of a filter unit according to the present disclosure in longitudinal section;

FIG. 2 is a view of an exemplary embodiment of the filter unit of FIG. 1 in cross section; and

FIG. 3 is a perspective view of the exemplary embodiment of the filter unit of FIG. 2.

Corresponding reference numerals indicate corresponding parts throughout the several views of the drawings.

### DETAILED DESCRIPTION

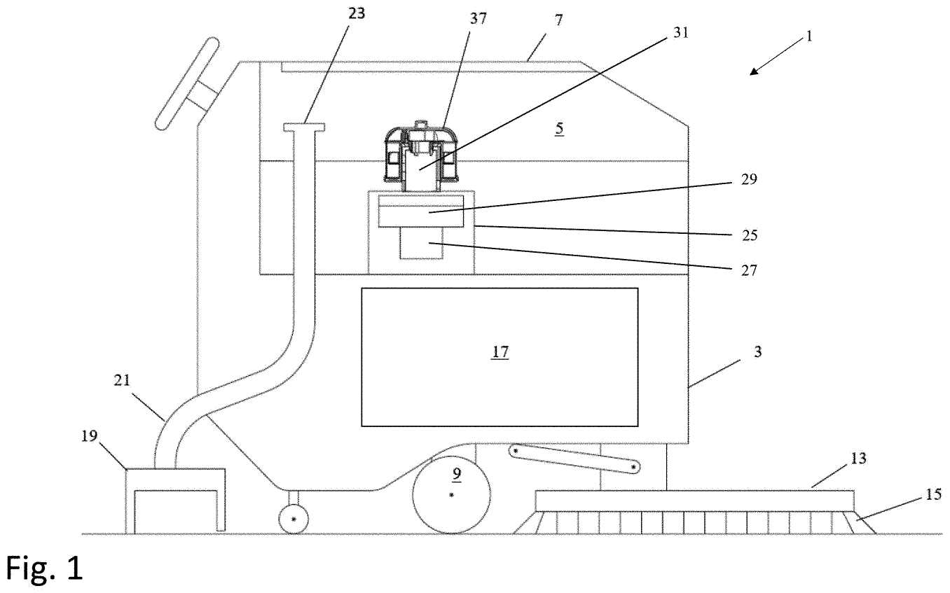

FIG. 1 shows, as an embodiment of a floor-cleaning machine, a scrubber dryer 1 which has in its housing 3 a dirty-water tank 5 which can be closed off by a cover element 7 which is held in a pivotable manner on the housing 3. The floor-cleaning machine 1 is furthermore provided with a chassis having wheels 9 such that the scrubber dryer 1 can be moved over a floor surface 11 to be cleaned. As can furthermore be gathered from FIG. 1, a brush head 13 is attached in a height-adjustable manner to the housing 3, wherein, in the preferred exemplary embodiment shown here, the brush head 13 has brush elements 15 which are driven in rotation and which can engage with the floor surface 11 to be cleaned in order to detach dirt therefrom, wherein, during the cleaning process, cleaning liquid is applied to the floor surface 11 to be cleaned from a fresh-water tank 17 (schematically illustrated), which is likewise provided in the housing 3.

As can also be gathered from FIG. 1, in the exemplary embodiment described here, a suction foot 19 is attached to the housing 3 of the floor-cleaning machine, which suction foot serves as a receiving device for cleaning liquid present on the floor surface 11 to be cleaned. The suction foot 19 is, in a manner known per se, configured in such a way that it has two sealing lips which are at a distance from one another and which, during cleaning operation, bear with an edge on the floor surface 11 to be cleaned, wherein the sealing lip facing in the direction of travel has inlet slits such that cleaning liquid applied beforehand can enter the region between the sealing lips. The region between the sealing lips is connected via a suction line 21 and an inlet connector 23 to the dirty-water tank 5, wherein the inlet connector 23 projects into the dirty-water tank 5.

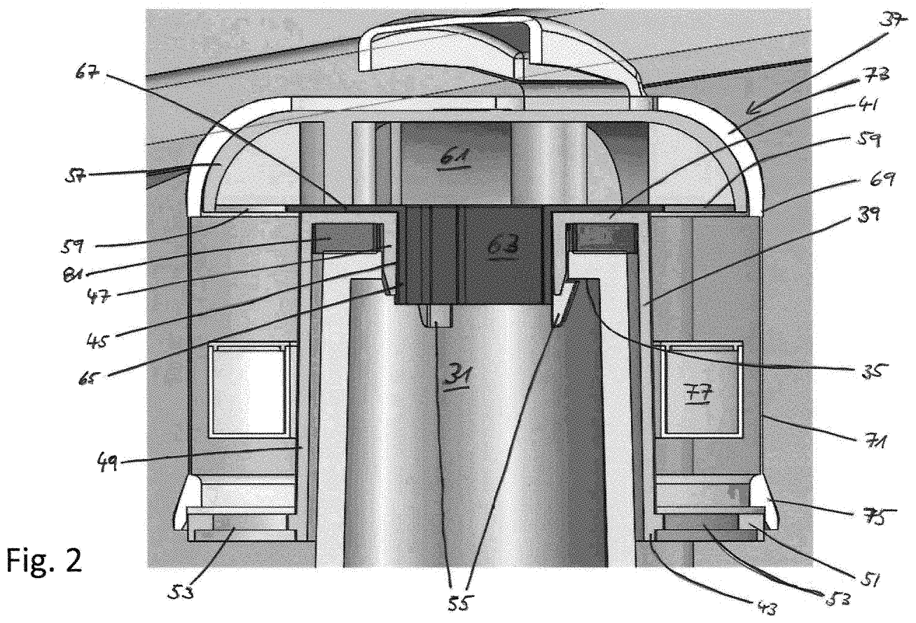

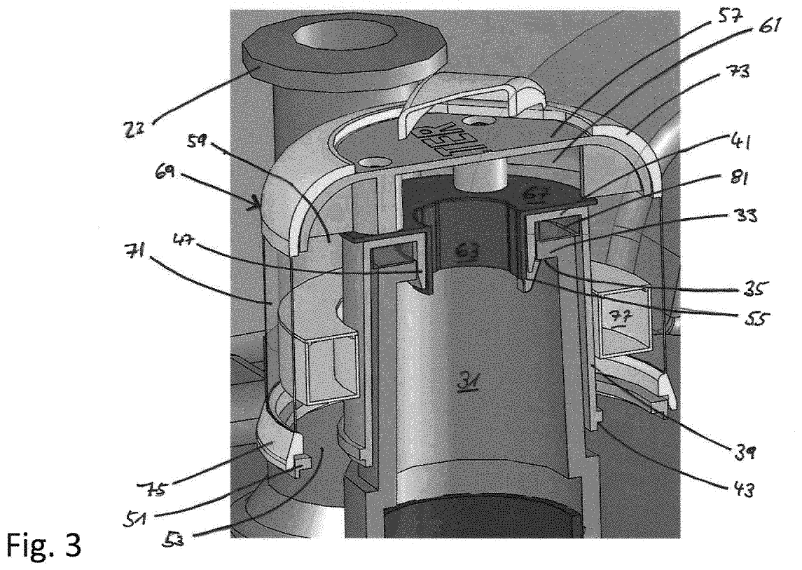

The scrubber dryer 1 furthermore has a suction turbine 25 in the housing 3, which suction turbine has a drive motor 27 and a fan wheel 29 (schematically illustrated) that is driven thereby, wherein the inlet of the suction turbine 25 is connected via a suction connector 31 to the interior of the dirty-water tank 5, wherein the free end 33 of the suction connector 31 is provided with an undercut 35 (see FIGS. 2 and 3). In this case, the undercut 35 forms an engagement element.

Attached to the suction connector 31 on the free end 33 thereof is an exemplary embodiment of a filter unit 37 according to the invention, which is illustrated in detail in FIGS. 2 and 3.

The filter unit 37 has a main body 39, which, in the preferred exemplary embodiment shown here, is of cylindrical and sleeve-shaped construction and surrounds the upper part of the suction connector 31, wherein the main body 39 extends between a first face end 41 and a second face end 43. Furthermore, the main body 39 has an inlet opening 45 at the first face end 41, wherein, in the region of the inlet opening 45, provision is made of a neck 47 which projects into the inlet (suction) connector 31 such that the neck 47 extends substantially parallel to an outer wall 49 of the main body 39 that forms a tubular portion. The main body 39 furthermore has, in the region of the second face end 43, an encircling flange 51 which extends away from the outer wall 49 in an outward direction and in which flange openings 53 are provided. FIGS. 2 and 3 furthermore show that, in the region of the first face end 41, provision is made at the inlet opening 45 of latching hooks 55 which, when the main body 39 has been mounted onto the suction connector 31, engage with the undercut 35 such that pulling of the main body 39 off from the suction connector 31 is then prevented.

The filter unit 37 moreover has a cover 57 which is fastened to the main body 39 on that side of the first face end 41 which faces away from the suction connector 31, wherein provision is made in the cover 57 of an entry opening 59, which is of encircling form in this preferred exemplary embodiment, and the cover 57 is moreover configured in such a way that provision is made therein of a fluid channel 61 via which the entry opening 59 is connected to the inlet opening 45 in the main body 39, so that a fluid such as air can enter the fluid channel 61 through the entry opening 59 and can then pass into the suction connector 31 through the inlet opening 45.

The filter unit 37 furthermore has a locking body 63 which comprises a cylindrical portion 65 which is configured in such a way that it can be inserted into the inlet opening 45 and the neck 47 of the main body 39 in such a way that it prevents the latching hooks 55 from pivoting inward and, in this way, from being brought out of engagement with the undercut 35. Consequently, the cylindrical portion 65 prevents the main body 39 from being able to be detached from the suction connector 31. Moreover, a collar 67 is provided on the locking body 63, said collar extending outward along the first face end 41 of the main body 39 and therebeyond. The locking body 63 is in this case clamped between the main body 39 or the first face end 41 thereof and the cover 57.

The filter unit 37 moreover has a sleeve-shaped filter element 69 whose cylindrical portion 71, which forms a circumferential surface, is formed from a sieve-like filter material and which also has a coupling portion 73 which is pushed over the cover 57, wherein there is a press fit between the cover 57 and the coupling portion 73, so that the filter element 69 cannot be readily pulled off from the cover 57. The cylindrical portion 71 composed of the filter material extends as far as the encircling flange 51 on the main body 39, wherein a ring 75 is provided on the cylindrical portion 71 on that end thereof which is remote from the coupling portion 73, said ring engaging with the encircling flange 51.

The filter unit 37 moreover has a substantially annular float body 77 which is arranged around the main body 39 and in particular the outer wall 49 of the latter, wherein the float body 77 is displaceable along the main body 39 or the outer wall 49 thereof between a closed position and an open position. If the float body 77 is in the closed position, it bears against the collar 67 of the locking body 63 and closes off the entry opening 59 in the cover 57, while, in the open position, at the lower end, it bears against the encircling flange 51 of the main body 39 and closes off the flange openings 53 provided therein. The float body 77 thus moves within an annular space 79 formed between the filter element 69, 71 and the main body 39. The float body 77 is in this case formed in such a way that, when the level in the dirty-water tank 5 rises, the float body 77 is displaced along the main body 39 toward the collar 67 of the locking body 63 and the entry opening 59 of the cover 57.

Finally, in the preferred exemplary embodiment described here, an elastic ring element 81 is provided between the free end 33 of the suction connector 31 and the main body 39, which elastic ring element is slightly compressed when the latching hooks 55 engage with the undercut 35. In this way, damage to the filter unit 37 due to vibrations or detachment of said filter unit from the suction connector is prevented. Moreover, manufacturing tolerances are compensated by way of the elastic ring element 81. Furthermore, the elastic ring element 81 can provide sealing action.

The exemplary embodiment of the filter unit 37 according to the invention can be fitted on the suction connector 31 of the scrubber dryer 1 in the following manner. Firstly, the elastic ring element 81 and the main body 39 are mounted onto the suction connector 31, wherein the latching hooks 55 are brought into engagement with the undercut 35. Then, the float body 77 is pushed onto the main body 39, wherein the float body 77 surrounds the main body 39 or the outer wall 49 thereof. Then, the locking body 63 is inserted into the inlet opening 45 and locks the latching hooks 55 in the engagement position. The fitting of the locking body moreover ensures the correct engagement of the latching hooks. Due to the collar 67, it is additionally achieved that the float body 77 can no longer be taken off. Subsequently, the cover 57 is fastened to the main body 39, wherein the locking body 63 is thus clamped. Finally, the filter element 69 can be pushed over the arrangement fitted beforehand, wherein the press fit between cover 57 and coupling portion 73 prevents simple detachment of the filter element 69.

During the operation of the scrubber dryer 1, air laden with dirty water and dirt is sucked through the suction line 21 and the inlet connector 23 from the suction foot 19 into the dirty-water tank 5 by means of the suction turbine 25, wherein the air passes through the cylindrical portion 71 of the filter element 69 and can then flow onward through the entry opening 59 and the inlet opening 45 to the suction turbine, wherein dirt particles are separated out at the cylindrical portion 71. When the dirty-water level in the dirty-water tank 5 rises, the float body 77 moves from the position shown in FIG. 5 further upward until, at a particular level, it is so close to the entry opening 59 of the cover 57 that, owing to the air flow, it is drawn against the collar 67 of the locking body 63 and closes off the entry opening 59. In this case, the current consumption of the suction turbine is changed, and it is indicated to a user that the dirty-water level in the dirty-water tank 5 is so high that the tank has to be emptied.

The flange openings 53 in the encircling flange 51 of the main body 39 moreover make it possible for foam to be able to enter the annular space 79, which likewise, even if the dirty-water level itself is still at a relatively low level, has the effect that the float body 77 is moved upward, so that likewise the entry opening 59 is closed off, whereby it is then indicated to the user that he or she has to empty the dirty-water tank 5.

If the cylindrical portion 71 of the filter element 69 is sufficiently dirty, air can pass through said portion only to a small extent, which then leads to the float body 77 being drawn toward the entry opening 59, and closing off the latter, owing to an air flow through the flange openings 53. In this case, a user has to clean the filter element 69, wherein he or she merely has to pull the coupling portion 73 off from the cover 57. In this case, however, it is not possible for the float body 77 to be detached because it is still trapped between the encircling flange 51 and the collar 67.

It is thus possible for the filter unit 37 to be fitted and also cleaned in a simple manner, wherein, when the filter unit 37 is cleaned and in particular when the filter element 69 is removed, there is no risk, in particular because of the locking body 63, of the float body 77 being lost. Moreover, the construction of the filter unit 37 is very compact since the filter unit is arranged only around the suction connector 31 and thus takes up relatively little space in the dirty-water tank 5.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference signs:

| | |
|---|---|
| 1 | Scrubber dryer |
| 3 | Housing |
| 5 | Dirty-water tank |
| 7 | Cover element |
| 9 | Wheel |
| 11 | Floor surface |
| 13 | Brush head |
| 15 | Brush element |
| 17 | Fresh-water tank |
| 19 | Suction foot |
| 21 | Suction line |
| 23 | Inlet connector |
| 25 | Suction turbine |
| 27 | Drive motor |
| 29 | Fan wheel |
| 31 | Suction connector |
| 33 | Free end |
| 35 | Undercut |
| 37 | Filter unit |
| 39 | Main body |
| 41 | First face end |
| 43 | Second face end |
| 45 | Inlet opening |
| 47 | Neck |
| 49 | Outer wall |
| 51 | Encircling flange |
| 53 | Flange opening |
| 55 | Latching hook |
| 57 | Cover |
| 59 | Entry opening |
| 61 | Fluid channel |
| 63 | Locking body |
| 65 | Cylindrical portion |
| 67 | Collar |
| 69 | Filter element |
| 71 | Cylindrical portion |
| 73 | Coupling portion |
| 75 | Ring |
| 77 | Float body |
| 79 | Annular space |
| 81 | Elastic ring element |

What is claimed is:

1. A filter unit (37) for a suction connector (31) in a dirty-water tank (5) of a floor-cleaning machine (1), the filter unit (37) comprising:
a substantially sleeve-shaped main body (39), which extends between a first face end (41) and a second face end (43) and has an inlet opening (45) at the first face end (41),
a substantially annular float body (77), which is arranged around the main body (39) and is displaceable along the main body (39) between a closed position and an open position,
a cover (57), which is arranged on the first face end of the main body,
wherein the cover (57) has at least one entry opening (59) which is configured to be closed off by the float body (77) when the latter is in the closed position and which is open when the float body (77) is at a distance from the closed position, and
wherein provision is made in the cover (57) of a fluid channel (61), which is configured to allow a fluid to flow from the entry opening (59) into the inlet opening (45), and
a sleeve-shaped filter element (69), which is arranged around the main body (39) in such a way that, between the main body (39) and the filter element (69), there is formed an annular space (79) in which the float body (77) is arranged so as to be displaceable between the closed position and the open position,
wherein the filter element (69) is formed at least partially from a filter material (71).

2. The filter unit (37) of claim 1, wherein the filter element (69) is held in a detachable manner on the cover (57).

3. The filter unit (37) of claim 1, wherein the main body (39) has an encircling flange (51) which extends away in an outward direction and against which the float body (77) bears when the float body (77) is in the open position, and
wherein the filter element (69) extends as far as the flange (51).

4. The filter unit (37) of claim 3, wherein the flange (51) has at least one flange opening (53) which is closed off by the float body (77) when the float body (77) is in the open position and which is opened up when the float body (77) has been displaced from the open position toward the closed position.

5. The filter unit (37) of claim 1, wherein, in a region of the inlet opening (45), the main body (12) has at least one latching element,
wherein the at least one latching element (55) is configured to engage with at least one engagement element (35) at the suction connector (31), and
wherein the main body (39) and the cover (57) are configured in such a way that, when the at least one latching element (55) is in engagement with the engagement element (35), a fluid connection between the entry opening (59) and the suction connector (31) is provided.

6. The filter unit (37) of claim 5, having a locking body (63), which has a cylindrical portion (65),
wherein the cylindrical portion (65) is inserted into the inlet opening (45) and is configured to counteract action of bringing the at least one latching element (55) out of engagement with respect to the suction connector (31).

7. The filter unit (4) of claim 6, wherein the locking body (63) has a collar (67) which extends beyond the main body (79) into the annular space (79),
wherein the float body (77) bears against the collar (67) if the float body (77) is in the closed position.

8. The filter unit (37) of claim 6, wherein the cover (57) and the main body (39) are components which are separate from one another, and
wherein the locking body (63) is arranged between the cover (57) and the main body (39).

9. The filter unit (37) of claim 5, wherein the at least one latching element include a latching hook (55).

10. The filter unit (37) of claim 1, having an elastic ring element (81) which bears against a surface of the main body (39) facing away from the cover (57) and which is provided to bear against the suction connector (31).

11. The filter unit (37) of claim 1, wherein the filter element (69) has a sieve-like circumferential surface.

12. The filter unit (37) of claim 1, wherein the main body (39) has a tubular portion (49) around which the float body (77) is arranged,
wherein the tubular portion (49) is adapted to be fitted over a suction connector (31) of a floor-cleaning machine (1).

13. A floor-cleaning machine (1) having a dirty-water tank (5),
a suction connector (31), which extends into the dirty-water tank (5),
a suction turbine (25), which is fluidically connected to an end of the suction connector (31) that is remote from the dirty-water tank (5) and which serves for generating negative pressure in the dirty-water tank (5),
a suction line (21, 23), which ends in the dirty-water tank (5), and which is connected to a device (19) for receiving liquid, by way of negative pressure, from a floor surface (11) to be cleaned,
wherein provision is made of a filter unit (37) which is mechanically connected to a free end (33) of the suction connector (31), which free end is arranged in the dirty-water tank (5), the filter unit (37) comprising:
a substantially sleeve-shaped main body (39), which extends between a first face end (41) and a second face end (43) and has an inlet opening (45) at the first face end (41),
a substantially annular float body (77), which is arranged around the main body (39) and is displaceable along the main body (39) between a closed position and an open position,
a cover (57), which is arranged on the first face end of the main body,
wherein the cover (57) has at least one entry opening (59) which is configured to be closed off by the float body (77) when the latter is in the closed position and which is open when the float body (77) is at a distance from the closed position, and
wherein provision is made in the cover (57) of a fluid channel (61), which is configured to allow a fluid to flow from the entry opening (59) into the inlet opening (45), and
a sleeve-shaped filter element (69), which is arranged around the main body (39) in such a way that, between the main body (39) and the filter element (69), there is formed an annular space (79) in which the float body (77) is arranged so as to be displaceable between the closed position and the open position,
wherein the filter element (69) is formed at least partially from a filter material (71).

14. The floor-cleaning machine (1) of claim 13, wherein the filter element (69) is held in a detachable manner on the cover (57).

15. The floor-cleaning machine (1) of claim 13, wherein the main body (39) has an encircling flange (51) which extends away in an outward direction and against which the float body (77) bears when the float body (77) is in the open position, and
wherein the filter element (69) extends as far as the flange (51).

16. The floor-cleaning machine (1) of claim 15, wherein the flange (51) has at least one flange opening (53) which is closed off by the float body (77) when the float body (77) is in the open position and which is opened up when the float body (77) has been displaced from the open position toward the closed position.

17. The floor-cleaning machine (1) of claim 13, wherein, in a region of the inlet opening (45), the main body (12) has at least one latching element,
wherein the at least one latching element (55) is configured to engage with at least one engagement element (35) at the suction connector (31), and
wherein the main body (39) and the cover (57) are configured in such a way that, when the at least one latching element (55) is in engagement with the engagement element (35), a fluid connection between the entry opening (59) and the suction connector (31) is provided.

18. The floor-cleaning machine (1) of claim 17, having a locking body (63), which has a cylindrical portion (65),
wherein the cylindrical portion (65) is inserted into the inlet opening (45) and is configured to counteract action of bringing the at least one latching element (55) out of engagement with respect to the suction connector (31).

19. The floor-cleaning machine (1) of claim 18, wherein the locking body (63) has a collar (67) which extends beyond the main body (79) into the annular space (79),
wherein the float body (77) bears against the collar (67) if the float body (77) is in the closed position.

20. The floor-cleaning machine (1) of claim 18, wherein the cover (57) and the main body (39) are components which are separate from one another, and wherein the locking body (63) is arranged between the cover (57) and the main body (39).

21. The floor-cleaning machine (1) of claim 20, wherein the at least one latching element include a latching hook (55).

22. The floor-cleaning machine (1) of claim 13, having an elastic ring element (81) which bears against a surface of the main body (39) facing away from the cover (57) and which is provided to bear against the suction connector (31).

23. The floor-cleaning machine (1) of claim 13, wherein the filter element (69) has a sieve-like circumferential surface.

24. The floor-cleaning machine (1) of claim 13, wherein the main body (39) has a tubular portion (49) around which the float body (77) is arranged,
wherein the tubular portion (49) is adapted to be fitted over a suction connector (31) of a floor-cleaning machine (1).
